(19) United States
(12) Patent Application Publication
(10) Pub. No.: US 2006/0240787 A1
(43) Pub. Date: Oct. 26, 2006

(54) Data transmitter and data transceiver incorporating SAW filter

(75) Inventors: Kyu Hwan An, Seoul (KR); Hak Sun Kim, Daejeon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/319,613

(22) Filed: Dec. 29, 2005

(30) Foreign Application Priority Data
Apr. 22, 2005 (KR) 10-2005-33738

(51) Int. Cl. H04B 1/04

(52) U.S. Cl. 455/118; 455/113

(57) ABSTRACT

The invention relates to a data transmitter and a data transceiver incorporating a passive device such as a SAW filter, which can modulate frequency by using the SAW filter in order to transmit digital data via analog communication path. The transmitter or transceiver generates at least two up/down-chirp signals having mutually discriminable nonlinear frequency modulation characteristics by modifying frequency modulation characteristics of chirp-modulating SAW filters, allocates the up/down-chirp signals according to preset bit binary information, and then selectively transmits one of the up/down-chirp signals corresponding to transmitting data.

### RELATED APPLICATION

The present application is based on and claims priority from Korean Application Number 2005-33738, filed Apr. 22, 2005, the disclosure of which is hereby incorporated by reference herein in its entirety.

### BACKGROUND OF THE INVENTION

1. Field of the Invention

The present invention relates to a wireless transceiver for transmitting/receiving data on wireless signals, and more particularly, a data transmitter and a data transceiver incorporating a passive device such as a Surface Acoustic Wave (SAW) filter, which can modulate frequency by using the SAW filter in order to transmit digital data via analog communication path.

2. Description of the Related Art

Recent studies have been carried out actively on mobile communication and sensor network standards such as Zigbee. In particular, Zigbee is 2.4 GHz wireless network standards for home automation and data communication characterized by low power, low cost and low communication speed. Zigbee is dual PHY type, and on the way of standardization in IEEE 802.15.4. Zigbee uses 2.4 GHz frequency band and Direct Secure Spread Spectrum (DSSS) modem type to constitute a large-scale wireless sensor network that transmits data at a rate of 20 to 250 kbps in 30-meter radius area.

Such a sensor network requires high-efficiency and lower power wireless transceivers that can ensure prolonged communication time by battery power for the sake of convenience in installation and use.

FIG. 1 is block diagrams illustrating a conventional data transceiver, in which FIG. 1(a) shows a transmitter structure, and FIG. 1(b) shows a receiver structure.

Referring to FIGS. 1(a) and (b), a conventional transmitter is so constructed to convert a transmitting data into an analog signal by using a digital-analog converter (DAC) 11, and then apply the analog signal to a Phase Lock Loop (PLL) 12 in order to control oscillation frequency of a Voltage Control Oscillator (VCO) 13.

Such FM modulation technique carries out transmission by varying frequency according to status value of transmitting data bit, in which the PLL 12 and the VCO 13 converts and outputs a transmitting signal into a corresponding frequency signal.

The frequency-modulated transmitting signal outputted from the VCO 13 is amplified by a power amplifier 14 to transmission power, and then sent to the antenna.

As shown in FIG. 1(b), a conventional receiver makes a radio signal received via an antenna pass through a pass filter 15 to selectively extract a preset band frequency signal, and amplifies this signal by using a Low Noise Amplifier (LNA) 16. Then, a frequency discriminator 17 discriminates frequency value from the received signal, and then an Analog/Digital Converter (ADC) 19 converts the discrimination result into digital data of 0 and 1 bits.

Not only the above-described frequency modulation transmitter but also most conventional transmitters used in communication units need active devices such as a PLL, VCO and mixer. However, there is a problem in that these active devices consume a large amount of power since at least a preset level of power should be supplied to these active devices in order to operate them.

In particular, a wireless communication unit to be used in a Zigbee wireless network essentially requires low power consumption design. However, low power consumption design can be restrictively applied to a conventional transceiver as described above.

Therefore, in order to establish a sensor network and the like, there are required novel transceivers which can be installed in low power and high efficiency communication units while minimizing use of active devices that fundamentally consume large amount of power.

Chirp modulation is one type of spectrum-spread modulation, which boosts or drops signal frequency within a preset spread spectrum for a preset time period. Such chirp modulation is carried out by using a Surface Acoustic Wave (SAW) filter that is realized as a dispersive transducer where delay times are designed different according to frequencies.

FIG. 2 illustrates a communication system using conventional chirp scheme. At a transmitting part, a period of pulse signal 21 is applied to an up-chirping SAW filter 22 and an output up-chirp signal 23 from the up-chirping SAW filter 22 is transmitted via an antenna. At a receiving part, there is installed a down-chirp SAW filter 24 which has frequency modulation characteristics opposite to the up-chirping SAW filter 22, such that the up-chirp signal 23 received via an antenna is applied to the down-chirping SAW filter 24. Then, the down-chirping SAW filter 24 carries out down-chirping on the signal 23, thereby outputting a pulse signal 25.

FIGS. 3(a) and (b) illustrates typical up/down-chirping signal characteristics. As shown in FIG. 3(a), the up-chirp signal is produced by dispersing a frequency signal of a preset band (e.g., 10 to 70 MHz) within a preset time period (e.g., 1 nsec), in which frequency variation to time shows linear increase. On the other hand, as shown in FIG. 3(b), the down-chirp signal is produced by dispersing a frequency signal of a preset band (e.g., 10 to 70 MHz) within a preset time period (e.g., 1 nsec), in which frequency variation to time shows linear decrease.

Such chirp modulation is used generally in radar systems such as a radar altimeter and aperture radar, but not in other fields associated with for example data transmission/reception.

### SUMMARY OF THE INVENTION

The present invention has been made to solve the foregoing problems of the prior art and it is therefore an object of the present invention to provide a data transmitter and a data transceiver which can modulate frequency by using a passive device such as a SAW filter in order to transmit digital data via analog transmission path.

In order to realize the foregoing object, the invention provides a data transmitter including: a pulse generator for outputting a pulse signal at a predetermined period; a switch having one input end connected to an output of the pulse generator and a plurality of output ends selectively connected to the input end so that the pulse signal is selectively outputted via one of the output ends; a surface acoustic wave filter array having a plurality of chirp surface acoustic wave filters each connected to each of the output ends of the switch to output up/down-chirp signals showing mutually discriminable non-linear frequency modulation characteristics; and a controller for allocating the up/down-chirp signals received from the SAW filter array to a preset bit data, respectively, and controlling the switch to output a corresponding one of the up/down-chirp signals in response to transmitting data input, whereby a transmitting data is modified into chirp signals having mutually discriminable nonlinear frequency modulation characteristics.

Preferably, the data transmitter of the invention may further include a power amplifier for amplifying and transmitting the up/down-chirp signals received from the surface acoustic wave filter array via an antenna.

Preferably, the surface acoustic wave filters may satisfy following equations:

$${S}_{up} ( t ) = A \cdot cos 2 π [ {f}_{0} + \frac{B}{2 T} t \{ 1 \pm C \cdot sin ( 2 π {nf}_{n} t ) \} ]$$

$$and / or$$

$${S}_{down} ( t ) = A \cdot cos 2 π [ {f}_{0} - \frac{B}{2 T} t \{ 1 \pm C \cdot sin ( 2 π {nf}_{n} t ) \} ]$$

where s is a chirp signal on time axis, A is the amplitude of the chirp signal s, B is spread spectrum, C is chirp modulation amplitude (|C|<1), T is chirp period, n is natural number larger than 0, indicating the number of chirp modulation within the chirp period T, fm is chirp modulation frequency, and time t is

$$t ∈ [ - \frac{T}{2} , \frac{T}{2} ] .$$

Preferably, the surface acoustic wave filter array may include: a first surface acoustic filter for chirp-modulating a pulse signal into an up-chirp signal having linear frequency increase characteristics; and a second surface acoustic filter for chirp-modulating a pulse signal into a down-chirp signal having linear frequency decrease characteristics.

In order to realize the foregoing object, the invention also provides a data communication unit incorporating a surface acoustic wave filter. The data communication unit includes a transmitter for allocating preset bit-unit information to a plurality of chirp signals having mutually discriminable nonlinear frequency modulation characteristics and converting a transmitting data to a corresponding one of the chirp signals; and a receiver for receiving the signal transmitted from the transmitter and discriminating frequency modulation status of the received signal to interpret received data.

Preferably, the transmitter may includes a pulse generator for outputting a pulse signal at a predetermined period; a switch having one input end connected to an output of the pulse generator and a plurality of output ends selectively connected to the input end so that the pulse signal is selectively outputted via one of the output ends; a surface acoustic wave filter array having a plurality of chirp surface acoustic wave filters each connected to each of the output ends of the switch to output up/down-chirp signals showing mutually discriminable non-linear frequency modulation characteristics; and a controller for allocating the up/down-chirp signals received from the SAW filter array to a preset bit data, respectively, and controlling the switch to output a corresponding one of the up/down-chirp signals in response to transmitting data input.

Preferably, the receiver may include a band-pass filter for filtering out-of-band components from the received signal before sending to the limiting amplifier; a low-pass filter for filtering noises from the signal discriminated by the frequency discriminator; and an analog-digital converter for converting the signal filtered by the low-pass filter into a digital data.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is block diagrams illustrating a conventional data transceiver;

FIG. 2 is a block diagram illustrating a general chirp communication system;

FIG. 3 is graphs illustrating frequency characteristics of general up/down-chirp signals;

FIG. 4 is graphs illustrating up/down-chirp signals modified according to the invention and diagrams illustrating SAW filters for outputting the chirp signals;

FIG. 5 is a block diagram illustrating a data transmitter according to the invention;

FIG. 6 is a block diagram illustrating a receiver in a data transceiver according to the invention;

FIG. 7 is graphs illustrating output signals of a limiting amplifier in a data receiver according to the invention; and

FIG. 8 is graphs illustrating data transmission/reception in a data transceiver according to the invention.

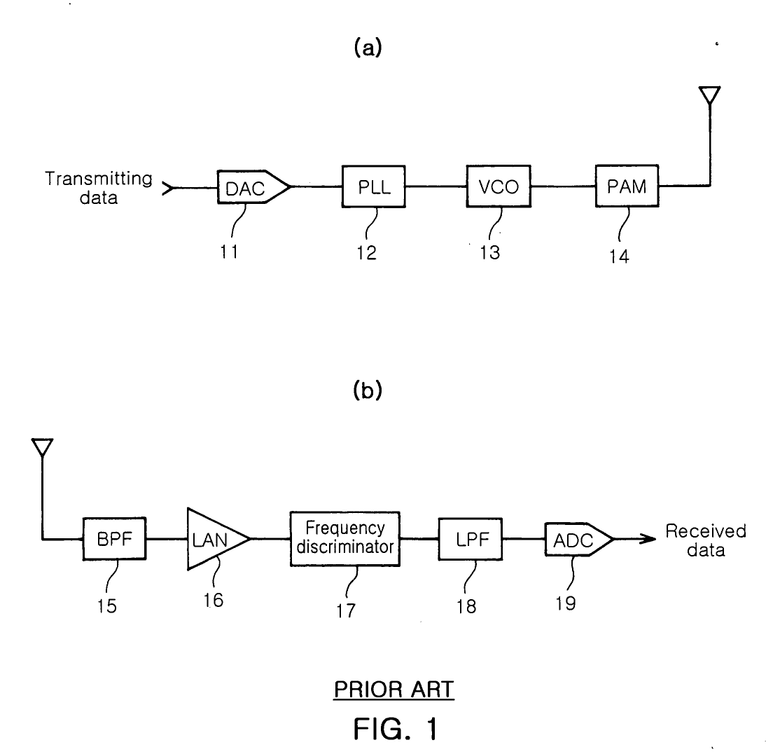

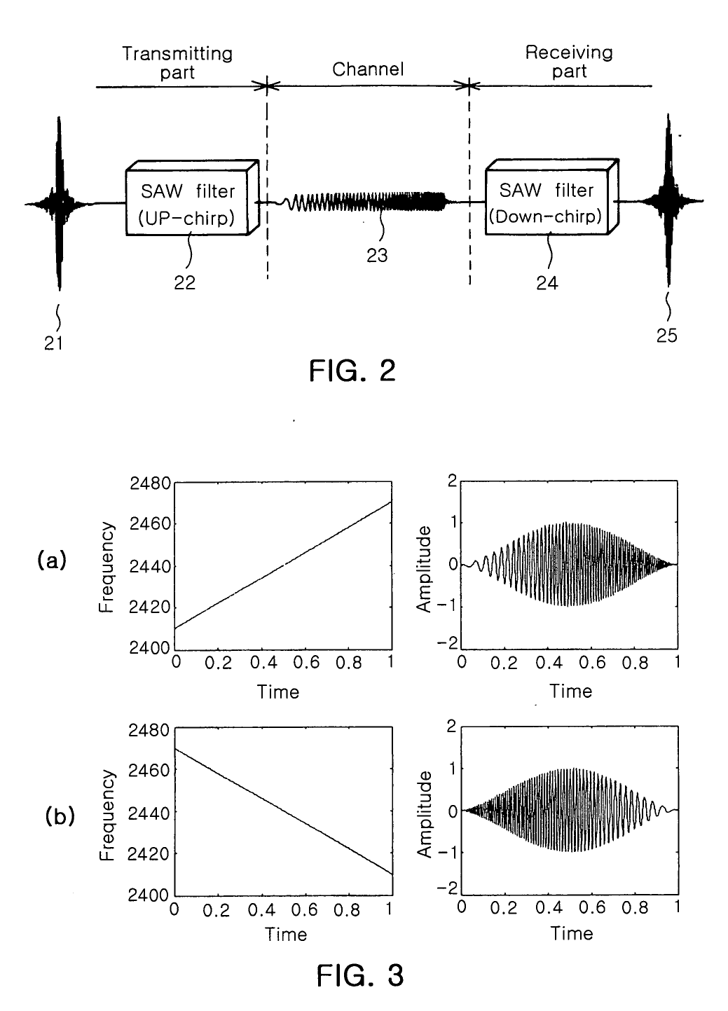

### DETAILED DESCRIPTION OF THE PREFERRED EMBODIMENT

The present invention will now be described in detail on its construction and operation with reference to the accompanying drawings.

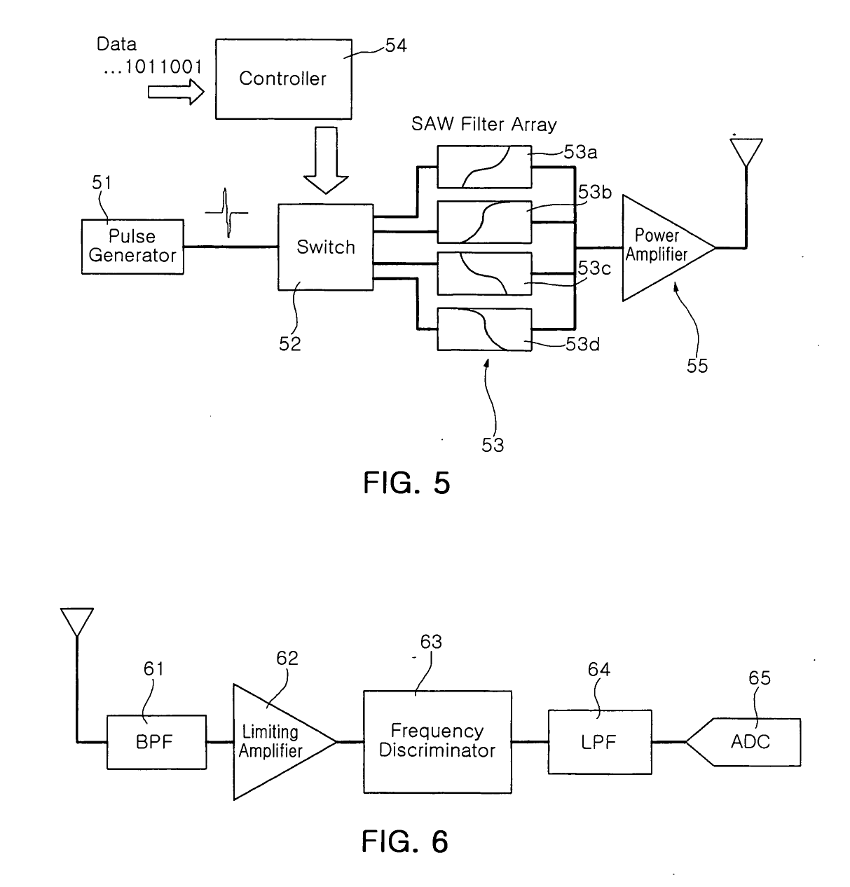

FIG. 5 is a block diagram illustrating a data transmitter according to the invention.

Referring to FIG. 5, the data transmitter of the invention includes: a pulse generator 51 for outputting a pulse signal at a predetermined period; a switch 52 having one input end connected to an output of the pulse generator 51 and a plurality of output ends selectively connected to the input end so that the pulse signal is selectively outputted via one of the output ends; a SAW filter array 53 having a plurality of chirp SAW filters 53a to 53d each connected to each of the output ends of the switch 52 to output up/down-chirp signals showing mutually discriminable non-linear frequency modulation characteristics; a controller 54 for allocating the up/down-chirp signals received from the SAW filter array 53 to preset bit data, respectively, and controlling the switch 52 to output a corresponding one of the up/down-chirp signals in response to transmitting data input; and a power amplifier 55 for amplifying and outputting the up/down-chirp signals received from the SAW filter array 53 via an antenna.

The pulse signal generated by the pulse generator 51 is sent to the SAW filter array 53 via the switch 52. In this case, an output chirp signal from the SAW filter array 53 is determined according to which one of the SAW filters 53a to 53d the pulse signal is applied. The controller 54 controls the switch 52 according to transmitting data's value corresponding to each pulse generation period so that a chirp signal allocated to the transmitting data is transmitted for one pulse period.

Accordingly, data quantity transmittable for one pulse period is determined according to the number of discriminable output chirp signals from the SAW filter array 53. That is, if the number of data bits transmittable for one period is set a and the number of chirp signals generated by the SAW filter array 53 (i.e., the number of the SAW filters 53a to 53d) is set N, a relation N=2^{a} is made. So, data quantity to be transmitted for one pulse period increases as more types of mutually discriminable chirp signals are generated from the SAW filter array 53.

For this purpose, the invention proposes modifying down/up-chirp signals according to predetermined regulations to increase the number of mutually discriminable chirp signals thereby enhancing data transmission rate.

That is to say, output up/down-chirp signals from the SAW filter array 53 are produced by modifying frequency modulation characteristics of typical up/down-chirp signals as shown in FIGS. 3a and 3b. More specifically, frequency-to-time profile of each up/down-chirp signal is modified into plus (+) or minus (−) sine waveform. Such modified chirp signals can be mutually discriminated by examining their frequency modulation status.

An output up-chirp signal sᵤₚ(t) from the SAW filter array 53 is defined by Equation 1 below, and an output down-chirp signal s_{down}(t) from the SAW filter array 53 is defined by Equation 2 below:

$$\begin{matrix}{S}_{up} ( t ) = A \cdot cos 2 π [ {f}_{0} + \frac{B}{2 T} t \{ 1 \pm C \cdot sin ( 2 π {nf}_{n} t ) \} ] , and & Equation 1 \\ {S}_{down} ( t ) = A \cdot cos 2 π [ {f}_{0} - \frac{B}{2 T} t \{ 1 \pm C \cdot sin ( 2 π {nf}_{n} t ) \} ] , & Equation 2\end{matrix}$$

where s is a signal on time axis (hereinafter will be referred to as “chirp signal”), A is the amplitude of the chirp signal s, B is spread spectrum, C is chirp modulation amplitude (|C|<1), T is chirp period, n is natural number larger than 0, indicating the number of chirp modulation within the chirp period T, fm is chirp modulation frequency, and time t is

$$t ∈ [ - \frac{T}{2} , \frac{T}{2} ] .$$

That is, the up/down-chirp signals according to the invention are a cosine signal with its frequency varying according to time t.

In the up/down-chirp signals as defined in Equations 1 and 2 above, chirp signal amplitude, spread spectrum, modulation amplitude and spread time are fixed, and frequency modulation characteristics of the chirp signals are varied as the modulation number n is changed.

For example, if n=0, ±C·sin(2Πnfₘ^{t}) in Equations 1 and 2 become 0. In this case, the chirp signals become typical up/down-chirp signals as illustrated in FIG. 3. If n is 1 or more, typical up/down-chirp signals in FIG. 3 are modified by ±C·sin(2Πnfₘ^{t}).

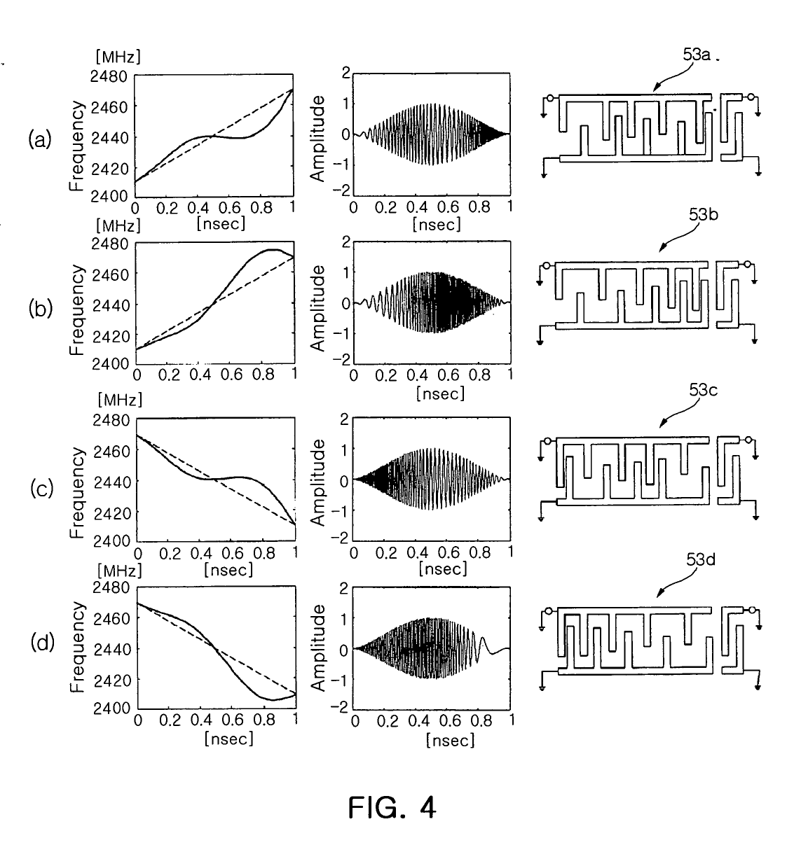

FIG. 4 shows up/down-chirp signals according to the invention where n=1.

Describing it in more detail, FIG. 4(a) shows an up-chirp signal profile produced by modifying frequency per time by +C·sin(2Πnfₘ^{t}). According to frequency modulation characteristics of this up-chirp signal, the profile rises gradually from low frequency, followed by a dropping section, and then rises again.

FIG. 4(b) shows an up-chirp signal profile produced by modifying frequency value per time by _C·sin(2Πnfₘ^{t}). According to frequency modulation characteristics of this up-chirp signal, the profile within spread time rises gradually, followed by sharp rise, and then drops.

FIG. 4(c) shows a down-chirp signal profile produced by modifying frequency value per time by _C·sin(2Πnfₘ^{t}). According to frequency modulation characteristics of this down-chirp signal, the profile drops gradually from high frequency, followed by rise, and then drops again.

FIG. 4(d) shows a down-chirp signal profile produced by modifying frequency value per time by +C·sin (2Πnfₘ^{t}). According to frequency modulation characteristics of this down-chirp signal, the profile drops gradually from high frequency, drops sharply, and then rises again.

According to the invention, even if n is larger than 1, frequency modulation characteristics of chirp signals are kept mutually discriminable.

The four chirp signals modified as above are mutually discriminable owing to frequency modulation. So, when the four chirp signals are allocated to data, it is possible to allocate two (2) bit data to one chirp signal. In addition, if four chirp signals modified by the invention are used in combination with typical up/down-chirp signals (shown in FIG. 3), mutually discriminable six (6) chirp signals are produced. Then, 3 bit data can be allocated to each chirp signal. As described above, the invention can enhance data transmission rate by modification of chirp signals.

Furthermore, a SAW filter for modifying chirp signals as shown in FIG. 4 can be produced by adjusting the spacing of SAW filter electrode fingers. Such a SAW filter design is well known in the art. FIG. 4 also shows schematic dispersive transducer circuits of SAW filters 53a to 53d, in which each of the dispersive transducer circuits disposed in the right side of a corresponding graph is adapted to execute chirp modulation making corresponding frequency modulation characteristics. The SAW filters 53a to 53d shown in FIG. 4(a)-(d) are illustrated as an example only, but the invention is in no way limited thereto.

Transmission process of the data transmitter of the invention will now be described for example with reference to the SAW filter array 53 having the four SAW filters 53a to 53d as shown in FIG. 4.

First, transmitting data is inputted to the controller 54. The transmitting data inputted to the controller 54 is divided per bit a (e.g., 2 bit), and status value of each bit is examined. For example, in case of 10110011 transmitting data input, data is divided into 10, 11, 00, 11.

The controller 54 has a mapping table where 2^{a} number of SAW filters 53a to 53a of the SAW filter array 53 are one-to-one matched with 2^{a} number of a-bit data. The controller 54 applies a control signal to the switch 52 so that the switch 52 is connected to a SAW filter (i.e., one of the SAW filters 53a to 53d) corresponding to a-bit transmitting data with reference to the mapping table.

By switching in response to this signal, the switch 52 delivers an output pulse signal from the pulse generator 51 to corresponding one of the SAW filters 53a to 53d.

Upon receiving the pulse signal from the switch 52, the SAW filter 53a to 53d chirp-modulates the input pulse signal to output a chirp signal having corresponding frequency modulation characteristics. The output chirp signal from the SAW filter 53a to 53d is amplified by the power amplifier 55 and then transmitted via the antenna.

According to the afore-mentioned process, binary data are transmitted as converted into chirp signals. The chirp signals of the invention are signal types similar to frequency-modulated signals, mutually discriminable owing to frequency modulation characteristics. So, a receiving part can restore original transmitting data 00, 01, 10, 11 from a received signal by detecting the frequency of the received signal and examining frequency modulation procedures. Accordingly, the receiving part can restore data from a received signal by examining frequency modulation status of a received signal for a predetermined time period (spread time), through synchronization with the pulse signal period.

FIG. 6 is a block diagram illustrating a receiver in a data transceiver according to the invention. The receiver in the data transceiver of the invention is generally similar to a general FM receiver.

Referring to FIG. 6, the receiver of the invention includes a limiting amplifier 62 for uniformly adjusting the magnitude of a signal received via an antenna and a frequency discriminator 63 for discriminating the frequency of the received signal amplified by the limiting amplifier 62.

The limiting amplifier 62 uniformly adjusts the magnitude of the received signal so that its frequency can be detected precisely. The frequency discriminator 63 discriminates the frequency of the received signal, which is amplified by the limiting amplifier, in order to examine the frequency modulation status of the received signal, thereby restore received data.

The frequency discriminator 63 can be also equipped with a function of examining the modulation status of the discriminated frequency to interpret the received data. It is also possible to set a CPU or the like of a communication unit to examine the modulation status of the frequency discriminated by the frequency discriminator 63 to interpret the received data.

The frequency discriminator 63 can execute frequency discrimination by counting the received signal at a predetermined sampling period. The frequency discriminator 63 can also have a function of examining the frequency modulation status in view of the discriminated frequency value in order to interpret the received data.

Furthermore, the receiver further includes a band-pass filter 61 for clearing off out-of-band components from a signal received via the antenna before sending it to the limiting amplifier 62 in order to prevent receive-sensitivity reduction owing to interference and noise, a low-pass filter 64 for clearing off noises from a signal that is frequency-discriminated by the frequency discriminator 63 and an Analog/Digital (A/D) converter 65 for converting the frequency-discriminated signal, which is filtered by the low-pass filter 64, into digital data.

The pass band of the band-pass filter 61 is set as spread spectrum of a SAW filter in the SAW filter array 53 of the receiver so that the SAW filter can clear off out-of-band noises or components thereby improving the reliability of received data.

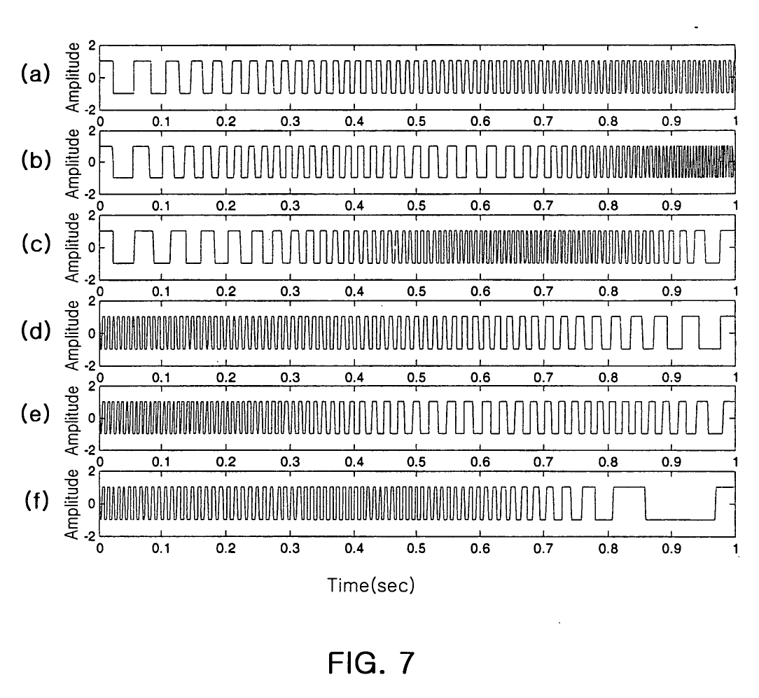

When the receiver of the invention having the above-described structure receives a signal transmitted from a data transmitter, outputs signals from the limiting amplifier 62 will be as shown in FIG. 7.

Referring to FIGS. 7, FIG. 7(a) shows a signal waveform from the limiting amplifier 62 where a received up-chirp signal has typical linear characteristics. It is noticeable from this waveform that the signal is frequency-modulated from low frequency to high frequency during spread time of 1 nsec. FIG. 7(b) shows a signal waveform from the limiting amplifier 62 where a received up-chirp signal is frequency-modulated into plus (+) sine wave by the SAW filter 53a as shown in FIG. 4(a). From this frequency waveform, it is noticeable that frequency modulation is carried out so that frequency rises from low frequency value, followed by drop in a middle section, and then rises again sharply. FIG. 7(c) shows a signal waveform from the limiting amplifier 62 where a received up-chirp signal is frequency-modulated into minus (−) sine wave by the SAW filter 53c. From this frequency waveform, it is noticeable that frequency modulation is carried out so that frequency rises gradually from low value but drops after 0.7 nsec point. FIG. 7(d) shows a signal waveform from the limiting amplifier 62 where a typical down-chirp signal is received. It is noticeable that the frequency of the received signal drops constantly from high frequency value. FIG. 7(e) shows a signal waveform from the limiting amplifier 62 where a received down-chirp signal is frequency-modulated into (+) sine wave as shown in FIG. 4(c). From this frequency waveform, it is noticeable that frequency drops until reaching about 0.6 nsec point, followed by rise until reaching about 0.8 nsec point, and then drops again. FIG. 7(f) shows a signal waveform from the limiting amplifier 62 where a received down-chirp signal is frequency-modulated into minus (−) sine wave as shown in FIG. 4(d). It is noticeable from FIG. 7(f) that the waveform generally maintains high frequency but drops sharply in a trailing section.

Comparing the signal waveforms shown in FIG. 7(a)-(f) with one another, it is noticeable that their frequency modulation statuses are definitely discriminable from one another. When counting the signals by dividing into three sections of a fixed interval, six chirp signals as shown in FIG. 7(a)-(f) can be discriminated from one another, and received data can be restored based upon above discrimination results.

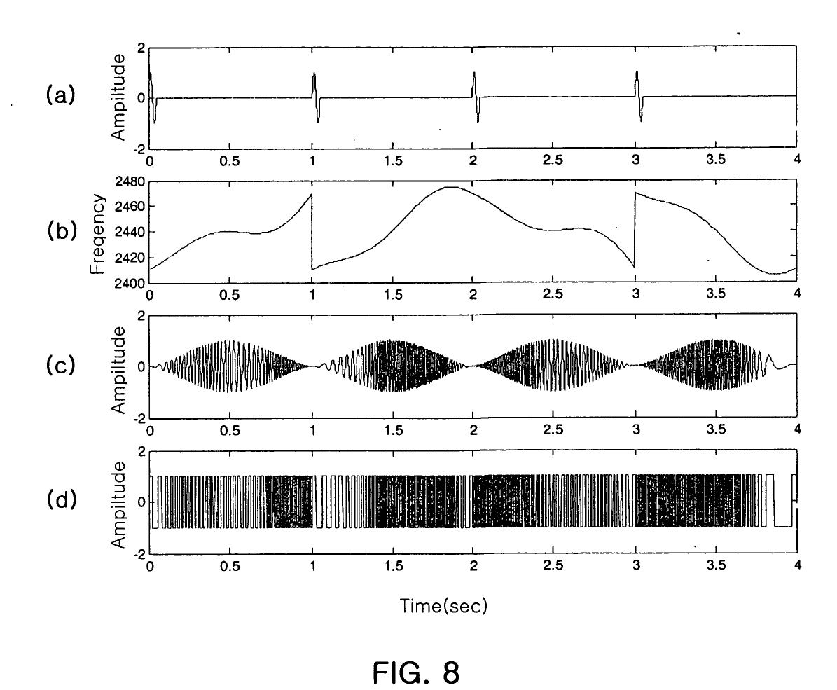

FIG. 8 illustrates signal transmission/reception carried out by a data transceiver which has transmitter as shown in FIG. 5 and a receiver as shown in FIG. 6. FIG. 8(a) shows an output pulse signal from the pulse generator 51, FIG. 8(b) shows frequency variation of a signal transmitted from a transmitting end, FIG. 8(c) shows a transmitting signal from the transmitter, and FIG. 8(d) shows an output signal from the limiting amplifier 62 of the receiver.

When pulse signals are generated at 1 nsec interval as shown in FIG. 8(a), frequency modulation characteristics at a transmitting end are varied according to transmitting data by 1 nsec interval. Then, chirp signals modulated according to respective frequency modulation characteristics are transmitted by 1 nsec interval as shown in FIG. 8(c). Upon receiving the transmitting signal of FIG. 8(c), the limiting amplifier 62 of the receiver produces output waveforms as shown in FIG. 8(d). Therefore, by tracking frequency modulation profiles by 1 nsec, it is possible to discriminate received signals, thereby interpreting data.

The afore-described data transmitter of the invention can be constructed without having active devices such as a mixer and PLL thereby reducing power consumption at the transmitting end as well as convert transmitting data to a wireless transmitting signal without having to use a digital modem or digital/analog converter thereby simplifying a transmitting end structure. Furthermore, by using various chirp signals discriminable from one another, it is possible to further increase data transmittable per pulse period.

As described hereinbefore, the present invention can reduce the number of active devices used in a transmitting end of a wireless communication unit that transmits data on wireless signals in order to further reduce power consumption at the transmitting end. This provides an excellent effect in that a communication unit of low power consumption can be designed. Furthermore, the data transmitter of the invention can generate mutually discriminable chirp signals to use in data transmission, thereby increasing data transmittable per one pulse period. Moreover, the data transceiver incorporating the transmitter of the invention can discriminate frequency-modulated status of chirp signals transmitted from such a transmitter, thereby interpreting data in a simple fashion.

While the present invention has been described with reference to the particular illustrative embodiments and the accompanying drawings, it is not to be limited thereto but will be defined by the appended claims. It is to be appreciated that those skilled in the art can substitute, change or modify the embodiments into various forms without departing from the scope and spirit of the present invention.

What is claimed is:

1. A data transmitter comprising:
a pulse generator for outputting a pulse signal at a predetermined period;
a switch having one input end connected to an output of the pulse generator and a plurality of output ends selectively connected to the input end so that the pulse signal is selectively outputted via one of the output ends;
a surface acoustic wave filter array having a plurality of chirp surface acoustic wave filters each connected to each of the output ends of the switch to output up/down-chirp signals showing mutually discriminable non-linear frequency modulation characteristics; and
a controller for allocating the up/down-chirp signals received from the SAW filter array to a preset bit data, respectively, and controlling the switch to output a corresponding one of the up/down-chirp signals in response to transmitting data input,
whereby a transmitting data is modified into chirp signals having mutually discriminable nonlinear frequency modulation characteristics.

2. The data transmitter according to claim 1, further comprising: a power amplifier for amplifying and transmitting the up/down-chirp signals received from the surface acoustic wave filter array via an antenna.

3. The data transmitter according to claim 1, wherein the surface acoustic wave filters satisfy following equation:
$${S}_{up} ( t ) = A \cdot cos 2 π [ {f}_{0} + \frac{B}{2 T} t \{ 1 \pm C \cdot sin ( 2 π {nf}_{n} t ) \} ] ,$$
where s is a chirp signal on time axis, A is the amplitude of the chirp signal s, B is spread spectrum, C is chirp modulation amplitude (|C|<1), T is chirp period, n is natural number larger than 0, indicating the number of chirp modulation within the chirp period T, fm is chirp modulation frequency, and time t is
$$t ∈ [ - \frac{T}{2} , \frac{T}{2} ] .$$

4. The data transmitter according to claim 1, wherein the surface acoustic wave filters satisfy following equation:
$${S}_{down} ( t ) = A \cdot cos 2 π [ {f}_{0} - \frac{B}{2 T} t \{ 1 \pm C \cdot sin ( 2 π {nf}_{n} t ) \} ] ,$$
where s is a chirp signal on time axis, A is the amplitude of the chirp signal s, B is spread spectrum, C is chirp modulation amplitude (|C|<1), T is chirp period, n is natural number larger than 0, indicating the number of chirp modulation within the chirp period T, fm is chirp modulation frequency, and time t is
$$t ∈ [ - \frac{T}{2} , \frac{T}{2} ] .$$

5. The data transmitter according to claim 1, wherein the surface acoustic wave filter array includes:
a first surface acoustic filter for chirp-modulating a pulse signal into an up-chirp signal having linear frequency increase characteristics; and
a second surface acoustic filter for chirp-modulating a pulse signal into a down-chirp signal having linear frequency decrease characteristics.

6. A data communication unit incorporating a surface acoustic wave filter, comprising:
a transmitter for allocating preset bit-unit information to a plurality of chirp signals having mutually discriminable nonlinear frequency modulation characteristics and converting a transmitting data to a corresponding one of the chirp signals; and
a receiver for receiving the signal transmitted from the transmitter and discriminating frequency modulation status of the received signal to interpret received data.

7. The data communication unit according to claim 6, wherein the transmitter includes:
a pulse generator for outputting a pulse signal at a predetermined period;
a switch having one input end connected to an output of the pulse generator and a plurality of output ends selectively connected to the input end so that the pulse signal is selectively outputted via one of the output ends;
a surface acoustic wave filter array having a plurality of chirp surface acoustic wave filters each connected to each of the output ends of the switch to output up/down-chirp signals showing mutually discriminable non-linear frequency modulation characteristics; and
a controller for allocating the up/down-chirp signals received from the SAW filter array to a preset bit data, respectively, and controlling the switch to output a corresponding one of the up/down-chirp signals in response to transmitting data input.

8. The data communication unit according to claim 7, wherein the transmitter further includes: a power amplifier for amplifying and transmitting the up/down-chirp signals received from the surface acoustic wave filter array via an antenna.

9. The data communication unit according to claim 7, wherein the surface acoustic wave filters satisfy following equation:
$${S}_{up} ( t ) = A \cdot cos 2 π [ {f}_{0} + \frac{B}{2 T} t \{ 1 \pm C \cdot sin ( 2 π {nf}_{n} t ) \} ] ,$$
where s is a chirp signal on time axis, A is the amplitude of the chirp signal s, B is spread spectrum, C is chirp modulation amplitude (|C|<1), T is chirp period, n is natural number larger than 0, indicating the number of chirp modulation within the chirp period T, fm is chirp modulation frequency, and time t is
$$t ∈ [ - \frac{T}{2} , \frac{T}{2} ] .$$

10. The data communication unit according to claim 7, wherein the surface acoustic wave filters satisfy following equation:
$${S}_{down} ( t ) = A \cdot cos 2 π [ {f}_{0} - \frac{B}{2 T} t \{ 1 \pm C \cdot sin ( 2 π n {f}_{n} t ) \} ] ,$$
where s is a chirp signal on time axis, A is the amplitude of the chirp signal s, B is spread spectrum, C is chirp modulation amplitude (|C|<1), T is chirp period, n is natural number larger than 0, indicating the number of chirp modulation within the chirp period T, fm is chirp modulation frequency, and time t is
$$t ∈ [ - \frac{T}{2} , \frac{T}{2} ] .$$

11. The data communication unit according to claim 7, wherein the surface acoustic wave filter array includes:
a first surface acoustic filter for chirp-modulating a pulse signal into an up-chirp signal having linear frequency increase characteristics; and
a second surface acoustic filter for chirp-modulating a pulse signal into a down-chirp signal having linear frequency decrease characteristics.

12. The data communication unit according to claim 6, wherein the receiver includes:
a limiting amplifier for adjusting the received signal to a preset magnitude; and
a frequency discriminator for discriminating frequency modulation status of the signal adjusted by the limiting amplifier to determine received data value.

13. The data communication unit according to claim 12, wherein the receiver includes:
a band-pass filter for filtering out-of-band components from the received signal before sending to the limiting amplifier;
a low-pass filter for filtering noises from the signal discriminated by the frequency discriminator; and
an analog-digital converter for converting the signal filtered by the low-pass filter into a digital data.
